(19) United States
(12) Patent Application Publication
(10) Pub. No.: US 2005/0089061 A1
(43) Pub. Date: Apr. 28, 2005

(54) Joint powerline/ultra-wide band system

(76) Inventors: Oleg Logvinov, East Brunswick, NJ (US); Brion Ebert, Easton, PA (US)

Correspondence Address: NORRIS MCLAUGHLIN & MARCUS, P.A., P O BOX 1018, SOMERVILLE, NJ, 08876, US

(21) Appl. No.: 10/928,812

(22) Filed: Aug. 27, 2004

Related U.S. Application Data
(60) Provisional application No. 60/498,763, filed on Aug. 28, 2003.

(51) Int. Cl. H04L 12/66

(52) U.S. Cl. 370/463

(57) ABSTRACT

A communications network interface system allows two independent communications networks to communicate with each other. The interface system provides that similar processing and control blocks required for interfacing with the respective networks are combined into a single, re-configurable and controllable processing module whose processing operations are controlled depending upon the network to or from which a communications signal is transmitted or received.

### CROSS REFERENCE TO RELATED APPLICATION

This application claims the benefit of U.S. Provisional Application No. 60/498,763 filed Aug. 28, 2003 assigned to the assignee of this application and incorporated by reference herein.

### FIELD OF THE INVENTION

The present invention relates generally to a powerline communications system for local area networks and wide area networks and, more particularly, providing a reconfigurable communications network interface system for communicatively interfacing with a powerline network and at least one other communications network.

### BACKGROUND OF THE INVENTION

A common power transmission network can be broken up into three (3) main segments. From a standard power substation, there is commonly a distribution access network of medium voltage power lines, configured in a loop and several miles in length that feed out to an area of homes and businesses. Then, at various points on the loop, step down transformers are situated that provide a series of 110-240 V low voltage access lines, depending on the country, to a small number of homes and/or businesses. At the end of each one of these lines, a meter or meters typically are present for each electricity customer served by that line. On the other side of each meter, there exists a typical in-home or in-building electricity distribution network inside a home or business. As known in the art, all three of the network segments can be used for transmitting high-speed data thereon.

In recent years, significant research also has been performed in the area of ultra-wideband (UWB) based wireless communication, where very high bandwidth communication is desired over relatively short distances. The research has led to the development of devices for a new type of network, commonly referred to a personal area network (PAN). The IEEE consortium established a technical working group to create a standard technology determination for these types of networks, known as the IEEE 802.15.3 task group. One of the technologies being considered is known as multi-band Orthogonal Frequency Division Multiplexing (OFDM), or MB-OFDM. This is a concept where multiple wide frequency bands are utilized, with OFDM modulation being utilized in each band, to achieve very high bandwidth communication. Although work continues in the area of PAN networks, it can be seen that a highly programmable, flexible OFDM based architecture can be realized to communicate between a powerline and a PAN network, while utilizing many of the same internal system hardware and software modules for both communication methods. This would allow for significant cost of scale reductions in a programmable or ASIC-based implementation.

Currently, OFDM-based communication methods are used for various types of mediums, both wired and wireless. OFDM methods can be used in a powerline network, such as described at www.homeplug.org, specification version 1.0, and also a wireless network, such as a Ultra-Wide Band (UWB) wireless network (See IEEE 802.15.3 July 2004 MAC Submission, DS-UWB Proposal Update, doc.: IEEE 802.15-04/140r7, and PHY proposals submitted September, 2003, Multi-band OFDM Physical Layer Proposal, doc.: IEEE P802.15-03/267r6, and Multi-band OFDM Physical Layer Proposal for IEEE 802.15 Task Group 3a, doc.: IEEE P802.15-03/268r1 for current examples of MAC and PHY design concepts).

A need exists for system and method for providing a relatively low cost, low power consumption and small sized communications network interface for interfacing with a plurality of communications networks, such as powerline and UWB networks which are based on, for example, OFDM Physical Layer Interface (PHY) and QoS capable Media Access Controller (MAC).

### SUMMARY OF THE INVENTION

In accordance with the present invention, a communications network interface system for interfacing with a plurality of communications networks, which preferably are OFDM based systems, provides for communications with at least two different communications networks and transferring information from a first of the two communications network to a second of the two communications networks. The communications interface system includes data signal processing modules whose processing operations are controlled in relation to the communications network from which a communications signal is received at the interface system or to which the interface system is to transmit a communications signal.

In a preferred embodiment, the communications interface system is for communicatively interfacing to OFDM-based communications networks which perform processing operations associated with functional blocks of an OFDM PHY and MAC system to provide for transfer of information and payload from one of the OFDM-based communications networks to another of the OFDM-based communications networks. In a further preferred embodiment, the interface system is for communicatively interfacing with a powerline network and an ultra-wideband wireless network.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a block diagram of a preferred exemplary OFDM based powerline communication system including a powerline network interface.

FIG. 2 is a block diagram of an exemplary OFDM based Ultra-Wideband (UWB) communication system including a UWB network interface.

FIG. 3 is block diagram of communications network interface system, in accordance with the present invention, communicatively interfaced with a powerline network and a UWB network.

### DETAILED DESCRIPTION OF THE INVENTION

For purposes of highlighting the features of the present invention of a communications network interface system for interfacing with a plurality of independent communications networks, the interface system is described below as including processing modules that provide for interfacing with an OFDM-based powerline network and an OFDM-based UWB wireless network, which oftentimes are present or desired to be present in the same geographical area. It is to be understood, however, that the interface system may be suitably designed to include processing modules corresponding to other communications networks in accordance with the present invention.

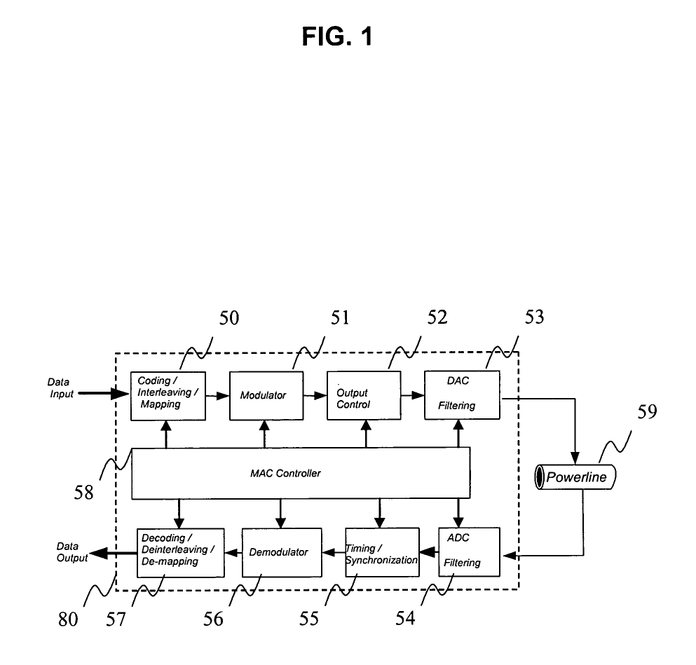

FIG. 1 illustrates the main functional blocks of a preferred embodiment of a powerline communications network coupled to a powerline network interface. Referring to FIG. 1, an OFDM power line communications (“PLC”) transceiver 80 establishes the physical connection and electronic signal link between a powerline network 59 and a data input/output (“I/O”) device, such as a computer (not shown), as well known in the art, and furthermore selectively controls the transmission of data on the powerline network 59. The PLC transceiver 80 is described below as containing modules, which perform PLC signal processing using techniques well known in the prior art, and which are modified in accordance with the present invention to perform processing based on the indicated mode of operation, for example, powerline or UWB. See, for example, U.S. patent application Ser. No. 10/211,033, filed Aug. 2, 2002 and Ser. No. 10/309,567, filed Dec. 4, 2002, each of which is assigned to the assignee of this application and incorporated by reference herein, for a description of conventional PLC transceiver construction and operation. It is to be understood that the modules of the PLC transceiver 80 described below as performing data or signal processing operations constitute a software module, a hardware module or a combined hardware/software module. In addition, each of the modules suitably contains a memory storage area, such as RAM, for storage of data and instructions for performing processing operations in accordance with the present invention. Alternatively, instructions for performing processing operations can be stored in hardware in one or more of the modules. The modules can be combined into a single integral module, or a plurality of composite modules, using techniques well known in the art.

Referring to FIG. 1, the PLC transceiver 80 includes a coding/interleaving/mapping module 50, a modulator module 51, an output control module 52 and a digital to analog converter (DAC) and filtering module 53 connected to one another in the recited sequence. The PLC transceiver 80 further includes an analog to digital converter (ADC) and filtering module 54, a timing/synchronization module 55, a demodulator module 56 and a decoding/de-interleaving/de-mapping module 57 connected to one another in the recited sequence. The media access (“MAC”) 58 has a control and parameter update interface between it and all of the aforementioned modules, and performs all of the access control and management functions of the PLC transceiver 80 with respect to communications occurring on the powerline network 59. The digital to analog converter (DAC) and filtering module 53 and the analog to digital converter (ADC) and filtering module 54 are also connected, normally through an analog front end (“AFE”) interface (not shown), to the powerline network 59.

The modules numbered 50 through 58 of the PLC transceiver 80 are well known prior art PLC transceiver components that can perform prior art PLC signal processing operations which are well known in the art.

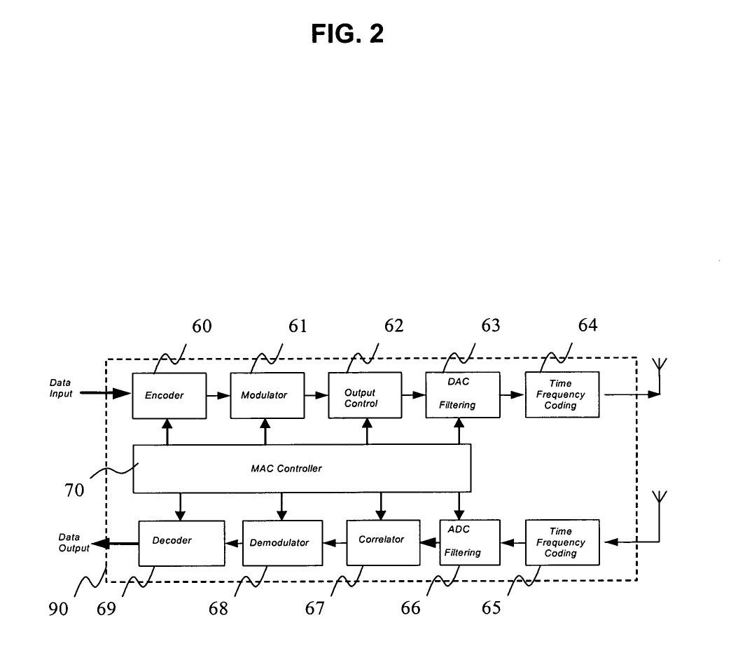

FIG. 2 is a preferred embodiment of an UWB transceiver 90 that establishes a wireless link between two OFDM-based UWB devices, such as a computer (not shown) and a PDA (personal digital assistant) device, or a video player device (DVD player or PVR (personal video recorder) device and a monitor or HDTV (high-definition television). UWB systems and devices have been in existence for many years, and the basic concepts are very well known in the art. The UWB transceiver 90 is described below as containing modules, which perform UWB signal processing using techniques well known in the prior art, and which are modified in accordance with the present invention to perform processing operations in accordance with the indicated mode of operation (Powerline or UWB). UWB based concepts are well known. See, for example, U.S. Pat. Nos. 5,687,169, and 5,677,927, incorporated by reference herein, which detail an ultra-wideband based system and method. It is to be understood that the modules of the UWB transceiver 90 described below as performing data or signal processing operations constitute a software module, a hardware module or a combined hardware/software module. In addition, each of the modules suitably contains a memory storage area, such as RAM, for storage of data and instructions for performing processing operations in accordance with the present invention. Alternatively, instructions for performing processing operations can be stored in hardware in one or more of the modules. The modules can be combined into a single integral module, or a plurality of composite modules, using techniques well known in the art.

Referring to FIG. 2, the UWB transceiver 90 includes an encoder module 60, a modulator module 61, an output control module 62, a digital to analog converter (DAC) and filtering module 63 and a transmitter time frequency coding module 64 connected to one another in the recited sequence. The UWB transceiver 90 further includes a receiver time frequency coding module 65, an analog to digital converter (ADC) and filtering module 66, a correlator module 67, a demodulator module 68 and a decoder module 69 connected to one another in the recited sequence. The MAC 70 has a control and parameter update interface between it and all of the aforementioned modules, and performs all of the access control and management functions of the UWB transceiver 90 with respect to communications taking place between wireless devices present in the area. The transmitter time frequency coding module 64 and the receiver time frequency coding module 65 are normally connected to an external antenna, which could be the same physical device or separate devices, depending on the design. The preferred embodiment of FIG. 2 illustrates separate antennas.

The modules numbered 60 through 69 of the UWB transceiver 90 are known prior art UWB transceiver functions, and their use in the preferred embodiment is only one example of a possible high level design architecture. One skilled in the art can envision other similar design architectures that would not deviate from the basis of this invention. The particular design of the UWB transceiver 90 is organized to show similar design breakdowns as shown in the PLC transceiver 80. The MAC 70 can be of a design known in the art, or can perform legacy functions of an UWB system, as well as incorporate the design concepts of a CSM (Common Signaling Mode) design, as referenced in the IEEE 802.15.3 MAC submission cited above.

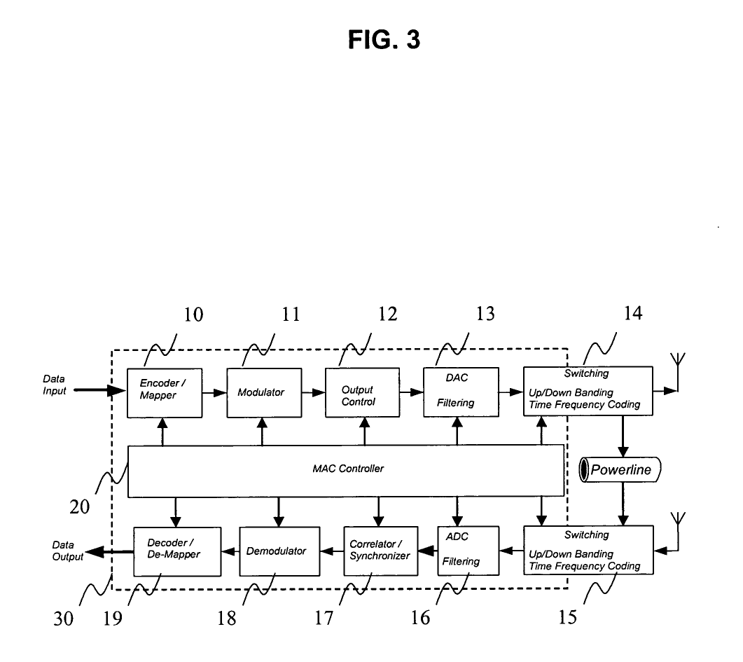

In accordance with the present invention, FIG. 3 is a preferred embodiment of a network communications interface system 30 communicatively interfaced with a powerline and UWB network and containing a hybrid architecture utilizing module functions associated with a PLC and a UWB-based interface design. The hybrid PLC/UWB transceiver 30 combines the similar functionalities of both PLC and UWB-based interface designs to facilitate reuse of design resources and functionalities of both referenced communication methods. The MAC module 20 is coupled to each of the encoder/mapper module 10, modulator module 11, output control module 12 and DAC filtering module 13 and upstream switching module 14 of the transmit processing chain, and also to the downstream switching module 15, ADC filtering module 16, correlator/synchronizer module 17, demodulator module 18 and decoder/de-mapper module 19 of the receive processing chain. Furthermore, each of the modules 10, 11, 12, 13, and 14 of the hybrid PLC/UWB transceiver 30, and also each of the modules 15, 16, 17, 18, and 19 of the hybrid PLC/UWB transceiver 30, is re-programmable and modifies its processing operations based on control and configuration parameter signals, which will identify which communication medium (powerline or UWB) will be utilized for a particular transmission or reception, based on the instruction of the MAC 20 and the current medium condition, of the inventive hybrid PLC/UWB transceiver 30.

In accordance with the present invention, the main advantage of a hybrid interface design, such as is illustrated in FIG. 3, is the reuse of components having similar functionalities, such as utilized in a legacy system, to provide for dual, as in the illustrated example, or a plurality of processing functionalities, depending upon the communications network to or from which the inventive interface system receives or transmits a communications signal containing payload and associated transmission information, where the transmission information contains communications event data representative of the type of communications network to be used for the communication. This combined processing functionality in the inventive interface system reduces cost, design size, power consumption and complexity. The very high-level block diagrams of FIGS. 1-3 illustrate that similar processing functionalities associated with an interface for different communications networks can be combined into a single communications interface system.

In the exemplary interface illustrated in FIG. 3, the similar functional blocks of the powerline and UWB network interfaces of FIGS. 1 and 2, respectively, are modified to be re-configurable and perform the functions required for each interface so as to obtain the corresponding functional blocks of the PLC transceiver 30. For transmit events, the following modules operate as follows. The encoder/mapper 10 performs the functions of encoding for both communications methods, as well as interleaving and mapping for PLC transmissions. The modulator 11 performs the OFDM modulation for either transmission event, utilizing different parameters for each. The output control module 12 performs the proper timing functions for each transmission type, again utilizing the appropriate parameters for each method as supplied by the hybrid MAC 20. The DAC/filtering module 13 preferably utilizes the same physical DAC for both methods, but utilizes different filtering parameters based on the frequency filtering requirements of each communications method. The upstream switching/up/down banding/time frequency coding module 14 performs different functions based on the transmission event, specifically performing coding based upon the proper parameters for each medium, performing up-banding for UWB transmissions and performing the on/off switching functions of each of the output stages for each communication medium.

For receiving events, the following modules operate as follows. The downstream switching/up/down banding/time frequency coding module 15 performs the receiver input stage switching, as well as the down banding for UWB receptions, and also performs the proper time coding functions for each type of reception. The ADC/filtering module 16 preferably utilizes the same physical ADC, and performs the proper filtering of the received signal based upon the communications method and the parameters supplied by the hybrid MAC 20. Also in accordance with the present invention, the correlator/synchronizer 17 performs the timing synchronization functions for a PLC reception, and the timing correlation functions for a UWB reception, again relying on the parameters supplied by the hybrid MAC 20. In addition, the demodulator 18 performs the OFDM signal demodulation for both reception types, utilizing the specific carrier maps supplied by the hybrid MAC 20, and the decoder/de-mapper 19 performs the function of decoding for both reception types, as well as the de-interleaving and de-mapping functions for PLC receptions. Also as readily understood in accordance with the present invention, the hybrid MAC 20 is modified to allow for “switching” the mode of the processing blocks based upon a particular communication event. For example, if a transmitting device (not shown) coupled to the transceiver 30 has data to transmit out the powerline interface, the transmitting device provides for the transmission of such information to the MAC 20 and the MAC 20, in turn, sets up the transmitter processing blocks for this type of interface, and performs the transmission. If a receiving device (not shown) coupled to the transceiver 30 detects a transmission occurring on the UWB interface, the receiving device provides for the transmission of such information to the MAC 20 and the MAC 20, in turn, sets up the receive processing blocks to receive data based on this type of interface, and performs the reception.

The inventive interface system is applicable to a common power line access network that provides electricity to homes, businesses and other entities, and a common local power line network in a home, business or other environment. Both of these networks can be used to support communications between electronic appliances coupled to these lines, as well as communications between a powerline network and a PAN or other type of wireless network. The inventive interface system is advantageous in such a system where both coverage and mobility are desired.

Thus, the inventive interface system reduces overall cost of an implementation of an interface with communications networks by combining similar functionalities of a plurality of communications network interfaces, which further results in a reduction in the overall system size and power consumption.

The inventive system can be implemented preferably on a single silicon integrated chip, or the like, to provide for a plurality of communications network interfaces, such as interfaces for both powerline and UWB networks. In a further preferred embodiment, a single-chip device incorporates at least digital portions (MAC, PHY, Traffic Handling Components, etc.) of the inventive interface system and furthermore incorporates mixed-signal functional components.

It is noted that system partitioning and functional block reuse, as shown in FIG. 3, are only exemplary, and a particular implementation of the inventive interface system may use separate blocks for final stages of media interfacing should that provide design and implementation advantages.

Although preferred embodiments of the present invention have been described and illustrated, it will be apparent to those skilled in the art that various modifications may be made without departing from the principles of the invention.

1. A communications network interface system for communicatively interfacing with a first communications network and a second communications network, wherein the first network is independent of the second network, the system comprising:
a media access controller (“MAC”) coupled to an encoder/mapper module and an upstream switching module, wherein the encoder/mapper module is for receiving input data containing upstream payload and associated transmission information and forwards the upstream payload in encoded form to the upstream module, wherein the upstream module includes first and second ports for transmitting a communications signal including the upstream payload over the first and second networks, respectively, and
wherein the MAC transmits upstream control signals to the encoder/mapper module and the upstream module based on communications event data included in the transmission information for a corresponding upstream payload, wherein the communications event data identifies whether the upstream payload is for transmission over the first network or the second network, wherein the encoder/mapper module and upstream module perform processing operations to generate the communications signal including the upstream payload for transmission over the first network or the second network in accordance with the upstream control signals.

2. The system of claim 1 further comprising a decoder/de-mapper module and a downstream switching module coupled to the MAC, wherein the decoder/de-mapper module is for transmitting downstream output data containing downstream payload received at the decoded/de-mapper module in encoded form from the downstream switching module, wherein the downstream switching module includes first and second ports for receiving a communications signal including the downstream payload and associated communications signal transmission information from the first and second networks, respectively,
wherein the downstream module generates communications event data representative of whether a communications signal including the downstream payload was received from the first network or the second network and forwards the downstream communications event data to the MAC, wherein the downstream module forwards the downstream payload for receipt by the decoder/de-mapper module, and
wherein the MAC, based on the downstream communication event data, transmits downstream control signals to the decoder/de-mapper module for causing the decoder/de-mapper module to perform processing on the downstream payload in accordance with the network from which the downstream payload was received at the downstream switching module.

3. The system of claim 1, wherein the first network is a powerline network and the second network is an ultra-wideband wireless network.

4. The system of claim 1, wherein the upstream switching module performs at least one of up/down banding and time frequency coding depending upon the upstream control signals received from the MAC.

5. The system of claim 2, wherein the downstream switching module performs at least one of up/down banding and time frequency coding depending upon the network from which the communication signal containing the downstream payload was received.

6. The system of claim 1, wherein the encoder/mapper module performs at least one of encoding and coding/interleaving/mapping depending upon the network over which the upstream payload is to be transmitted from the upstream switching module.

7. The system of claim 2, wherein the decoder/de-mapper module performs at least one of decoding and decoding/deinterleaving/de-mapping depending upon the network from which the downstream payload was received at the downstream switching module.
